(19) United States
(12) Patent Application Publication
(10) Pub. No.: US 2026/0091619 A1
(43) Pub. Date: Apr. 2, 2026

(54) 3D SIPES IN PNEUMATIC TIRES

(71) Applicant: CEAT LIMITED, Halol (IN)

(72) Inventors: Akhil Dev M, Halol (IN); Prashant DHOLIYA, Halol (IN); Ankit DIXIT, Halol (IN); Anurag YADAV, Halol (IN)

(21) Appl. No.: 19/110,393

(22) PCT Filed: Aug. 14, 2024
(86) PCT No.: PCT/IN2024/051493

§ 371 Date: Mar. 10, 2025

(30) Foreign Application Priority Data
Aug. 14, 2023 (IN) 202321054672

(51) Int. Cl. B60C 11/12

(52) U.S. Cl. CPC B60C 11/1218; B60C 2200/04

(57) ABSTRACT

The present subject matter relates to 3D sipes that are disposed of laterally in one or more tread blocks of a tire. Each of the one or more 3D sipes of the tire has a zig-zag shape in radial, lateral, and circumferential directions. Each of one or more 3D sipes also has a protrusion and a recess The 3D sipes improve the overall steering stability performance of the tire in harsh conditions.

### TECHNICAL FIELD

The present subject matter relates, in general, to vehicle tires and, particularly, but not exclusively, to vehicle tires having tread blocks.

### BACKGROUND

Tires support load of a vehicle and impact handling, drivability, and safety of the vehicle.

A tire has a crown or center region, a shoulder region, and beads on either side of the center region. The center region may be understood as an outer region of the tire formed along a complete circumference of the tire and spreads along a width of the tire, which contacts with a surface during rotation. The beads may be understood as the edges of the tire. The beads contact with a wheel during the mounting of the tire. The shoulder region is a portion of the tire joining the center region and the beads of the tire.

Vulcanized and treated rubber that is applied on the center region of the tire is called a tread of the tire. In some tires, the tread amongst other constituents, such as tread blocks, includes sipes. The sipes are small, thin slots molded into the tire's tread block that create additional tread surface area for increased grip in wet, icy, and snowy conditions. In other words, the sipes improve the tire's grip on wet, snow, and ice-covered surfaces, optimizing the braking, handling, overall performance, and lifespan of the tire. Hence, the sipe's configuration has a crucial role in tire life, vehicle maneuvering, safety, and ease of driving.

### BRIEF DESCRIPTION OF DRAWINGS

The detailed description is provided with reference to the accompanying figures. The left-most digit of a reference number identifies the figure in which the reference number first appears in the figures. The same numbers are used throughout the drawings to reference like features and components.

FIG. 1 illustrates a top view of a 3D sipe in a tread block of a tire, in accordance with an implementation of the present subject matter;

FIG. 2A illustrates a front view of the 3D sipe depicting a position of an alternate protrusion and a recess in the 3D sipe under normal loading conditions, in accordance with an implementation of the present subject matter;

FIG. 2B illustrates another front view of the 3D sipe depicting a position of the alternate protrusion and a recess under fully loaded conditions, in accordance with an implementation of the present subject matter;

FIG. 2C illustrates a profile of the protrusion and the corresponding recess in the 3D sipe, in accordance with an implementation of the present subject matter;

FIG. 2D illustrates the 3D sipe depicting position of a projection and the protrusion and recess in the 3D sipe, in accordance with an implementation of the present subject matter; and

FIG. 3 illustrates another front view of the 3D sipe, in accordance with an alternate implementation of the present subject matter;

### DETAILED DESCRIPTION OF DRAWINGS

Generally, pneumatic tires include finely carved tread patterns as well as a plurality of sipes formed on a portion of a tire that contacts the road or the ground. The sipes are used to improve the acceleration performance, braking performance, and steering stability performance of the tires under harsher conditions, for example in wet, icy, and snowy conditions. While smaller, individual tread blocks in tires do increase traction, they also increase the risk of tread block distortion which reduces fuel efficiency, handling performance, and tread life. Sipes are more effective for increasing the traction and surface area of the tire without negatively affecting these aspects.

Often, three-dimensional (3D) sipes in conventional commercial tires face deformation under dynamic loading due to improper interlocking, thereby creating an uneven surface which may consequently make the tread blocks unstable. Due to this, the performance of the tire may get compromised. Further, in conventional tires with 3D sipes, the deformation of the tread blocks in a fully loaded condition often leads to the complete closure of the 3D sipes. Hence, the tread block may appear and serve to function like a single tread block instead of two blocks separated by the sipe. This may lead to a condition of no biting edge on the tread blocks, resulting in poor wet performance. Poor wet performance, especially when a vehicle is fully loaded, may be fatal.

Thus, there exists a need for a technique that counters deformation in tread blocks of a tire and also avoids complete closure of the sipes without adversely affecting other performance parameters.

To this end, the present subject matter provides for a pneumatic tire having improved rigidity of tread blocks that address the deficiencies of the conventional tire treads, in particular, complete closure of the sipes and poor wet performance resulting therefrom.

In accordance with an embodiment of the present subject matter, the pneumatic tire comprises one or more 3D sipes that are disposed of laterally in one or more tread blocks. Each of the one or more 3D sipes of the tire has a zig-zag shape in radial, lateral, and circumferential directions. Each of the one or more 3D sipes has a first wall and a second wall on either side of the lateral direction of the pneumatic tire. The first wall has a pattern defined by a protrusion and a recess, and the second wall has a pattern corresponding to the pattern of the first wall. The protrusion and recess have a flat interfacing surface. Further, a height of the protrusion and the recess lies in a range of 35-50% of a width of the 3D sipe, and a distance of the protrusion and the corresponding recess from a top surface of the sipe lies in a range of 10-20% of a depth of the 3D sipe, and a length of the flat interfacing surface lies in range of 10-25% of the depth of the 3D sipe.

Furthermore, at least one projection is formed between a consecutive protrusion and recess on either the first wall or the second wall that prevents a complete engagement of the protrusion and the corresponding recess under a fully loaded condition. A distance of the consecutive protrusion and recesss from a bottom surface of the 3D sipe lies in a range of 30-60% of the depth of the 3D sipe. The height of at least one projection lies in a range of 10-15% of the width of the 3D sipe, and a width of the at least one projection lies in a range of 10-15% of the depth of the 3D sipe.

The above and other features, aspects, and advantages of the subject matter will be better explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

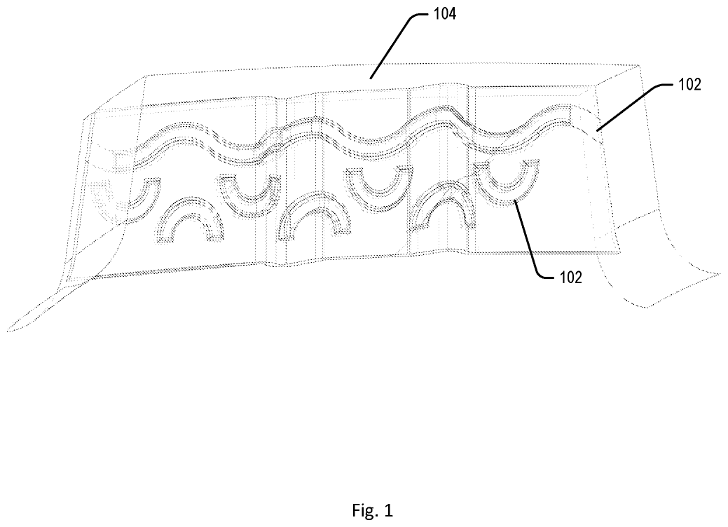

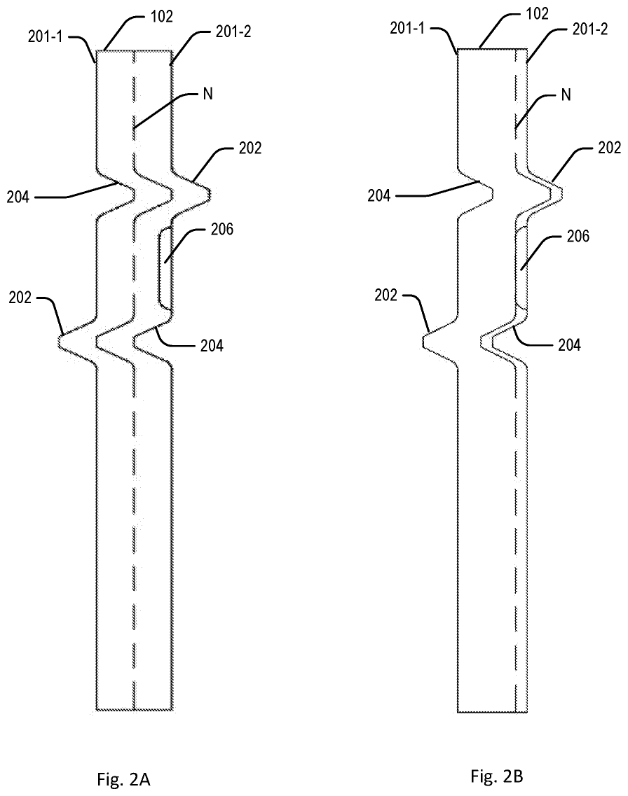

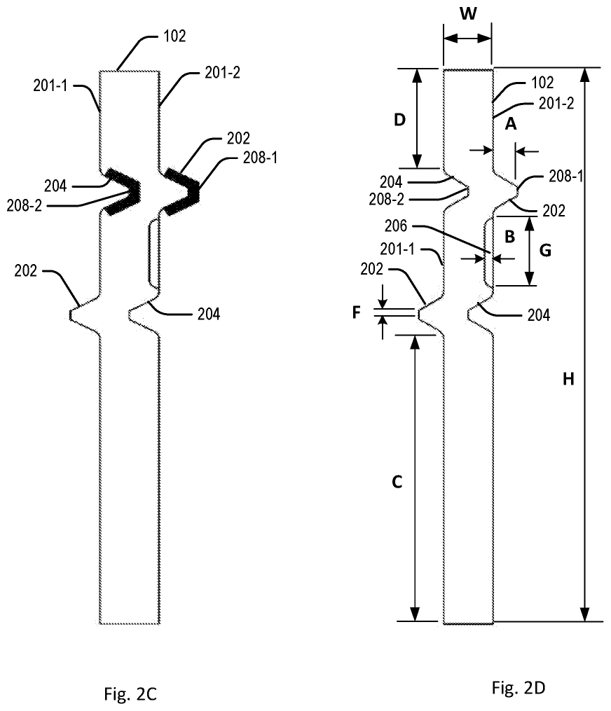

FIG. 1 illustrates a top view of a 3D sipe (hereinafter referred to as sipe 102) in a tread block 104 of a tire, in accordance with an example implementation of the present subject matter. In an implementation of the present subject matter, the sipe 102 has a zig-zag shape in radial, lateral, and circumferential directions of tread blocks 104 of the tire. The tire may be a passenger car tire or a TBR tire, in one example. The sipe 102 of the present invention includes a plurality of protrusions (illustrated in FIGS. 2A-2D), recesses (illustrated in FIGS. 2A-2D), and projections (illustrated in FIGS. 2A-2D) between the alternate protrusion and the recess. As will be explained hereinafter in detail, the protrusions, recesses, and projections are provided in a configuration that provides superior interlocking of the sipes 102 when a tangential force or a normal load is applied on the tire, thereby improving the overall stiffness of the tread blocks of the tire. The projections are provided to prevent a complete closure of the sipes 102 even under fully loaded conditions and thereby improve the traction of the tire.

FIG. 2A illustrates a front view of the sipe 102 depicting a position of the alternate protrusions 204 and the recesses 202 in the sipe 102 under normal loading conditions, in accordance with an implementation of the present subject matter. FIG. 2B illustrates another front view of the sipe 102 depicting a position of the alternate protrusions 204 and the recesses 202 under fully loaded conditions, in accordance with an example implementation of the present subject matter. FIG. 2C illustrates a profile of the protrusions 204 and the corresponding recesses 202 in the sipe 102, in accordance with an implementation of the present subject matter. FIG. 2D illustrates the sipe 102 depicting position of a projection 206 and the protrusions 204 and recesses 202 in the sipe 102, in accordance with an implementation of the present subject matter. Since FIGS. 2A-2D illustrate an arrangement relationship of a plurality of elements constituting the sipe 102, for the sake of ease of explanation, FIGS. 2A-2D are explained together.

As shown in FIG. 2A, the sipe 102 comprises a first wall 201-1 and a second wall 201-2 along the lateral direction of the tire. The first wall 201-1 has a consecutive pattern of a protrusion 204 and a recess 202, and the second wall 201-2 has a pattern corresponding to the pattern of the first wall 201-1. The sipe 102 further comprises the projection 206 which is formed between a consecutive protrusion 204 and recess 202 on either the first wall 201-1 or the second wall 201-2. An imaginary line (shown by dashed line N) between the first wall 201-1 and the second wall 201-2, as shown in FIG. 2A, shows a deflecting position or an extent of deflection of the protrusions 204 and recesses 202 formed on opposing walls of the sipe 102 towards each other, for example, the first wall 201-1 and the second wall 201-2, under normal loading conditions. In an example, a cross-section of the protrusions and the recess may be but is not limited to triangular.

FIG. 2B depicts the sipe 102 under dynamic loading or a fully loaded condition. As the tire rotates, rolling surface exerts a lateral force, a normal force, and a tangential force on the tire which causes deformation in the tread blocks, such as the tread block 104. Due to deformation in the tread blocks, the protrusion 204, and the corresponding recess 202 tend to interlock each other, and more so under the fully loaded condition. As discussed above, in the conventional sipes, under the fully loaded conditions, the interlocking of the protrusions 204, and the corresponding recesses 202 leads to the complete closure of the sipe, which may lead to a condition of a near disappearance of the biting edge on the tread blocks, resulting in poor wet performance.

To avoid the complete closure of the sipe, the sipe 102 as shown in FIG. 2B includes the projection 206 between the consecutive protrusion 204 and recess 202 on either the first wall 201-1 or the second wall 201-2. Due to this projection 206, under the fully loaded condition, when the protrusion 204 and the corresponding recess 202 on either side of the first wall 201-1 and the second wall 201-2 of the sipe 102 deflect towards each other, the projection 206 comes in between interfacing surfaces (illustrated in FIG. 2B) of the protrusion 204 and the corresponding recess 202, thereby preventing a complete closure of the sipe 102. For instance, as shown in FIG. 2B, the imaginary line N shows the extent of the deflection of the protrusions 204 and recesses 202 on the first wall 201-1 towards the corresponding recesses 202 and the protrusions 204 on the second wall 201-2. The projection 206 prevents the interfacing surfaces of the protrusion 204 and recess 202 on the first wall 201-1 to come in a direct contact with the interfacing surfaces of the corresponding recesses 202 and the protrusions 204 on the second wall 201-2, thereby preventing the complete closure of the sipe 102.

In an example embodiment, where there is multiple protrusion 204 and recess 202, the projection 206 may be provided anywhere in between the protrusion 204 and recess 202. However, in case of a small 3D sipe, there may be a single protrusion 204 and recess 202, for example, one wall, such as the first wall 201-1 having a protrusion 204 and the other wall, such as the second wall 201-2 having the corresponding recess 202. In this case, the projection 206 may be provided above or beneath the protrusion 204 or recess 202.

As shown in FIG. 2C, each of the alternating protrusion 204 and the corresponding recess 202 has a flat interfacing surface 208-1, 208-2. The flat interfacing surface 208-1, 208-2 ensures proper locking of each of the alternating protrusion 204 and the corresponding recess 202 even if the first wall 201-1 is offset due to shear force or combination of the tangential force and the lateral force under the fully loaded condition. Further, a side wall of the protrusion and a side wall of the corresponding recess extend with respect to lateral direction of the sipe 102 and terminate at the flat interfacing surface 208-1, 208-2.

FIG. 2D depicts a front view of the sipe 102 in the radial direction of the pneumatic tire and shows the dimensional details of the protrusion 204, recess 202, projection 206, and the flat interfacing surface 208-1, 208-2 within the sipe 102. In an example embodiment of the present subject matter, the sipe 102 has width W and depth H. The protrusion 204 and recess 202 have predefined height A from a surface of the respective wall 201-1, 202-2 that lies in a range of 35-50% of the width W of the sipe 102. Further, a distance D of the protrusion 204 and the corresponding recess 202 from top surface of the sipe 102 lies in the range of 10-20% of depth H of the sipe 102. The top surface of the sipe 102 is aligned with top surface of the tread block. The projection 206 that is formed between consecutive protrusions 204 and recesses 202, has a predefined height B from the surface of the respective wall 201-1, 201-2 that lies in a range of 10-15% of the width W of the sipe 102. The projection 206 also has a predefined width G along the surface of the respective wall 201-1, 201-2 that lies in a range of 10-15% of the depth H of the sipe 102. Further, a distance C of the consecutive protrusions 204 and recesses 202 from bottom surface of the sipe 102 lies in range of 30-60% of depth H of the sipe 102. Furthermore, the flat interfacing surface F of each of the protrusion 204 and recess 202 of the sipe 102 has a predefined length that lies in a range of 25% of the depth H of the sipe 102. In an example embodiment of the present subject matter, the depth of the sipe may lie at 85% of the non-skid depth of the tire's tread.

In yet another example embodiment of the present subject matter, the depth of the sipe 102 may vary with respect to the non-skid depth of the tread block. For example, in case of passenger car radial (PCR) tire, the depth of the sipe 102 may lie in range of 6 mm to 12 mm of the non-skid depth of the tread block 104. On the other hand, in case of truck/bus radial (TBR) tire, the depth of the sipe 102 may lie in range of 12 mm to 20 mm of the non-skid depth of the tread block 104.

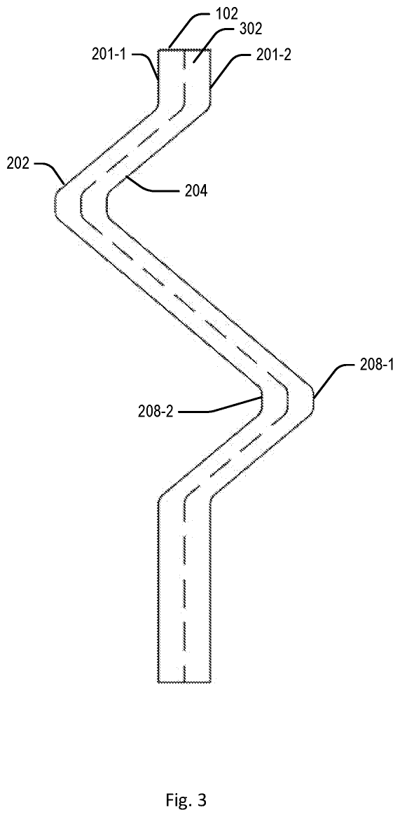

FIG. 3 illustrates another front view of the sipe 102, in accordance with an alternate implementation of the present subject matter. Although in exemplary embodiments described in reference to FIGS. 2A to 2D, the protrusions 204 and the recesses 202 on either of the first wall 201-1 and the second wall 201-2 of the sipe 102 are shown to be arranged alternatively along the length of the sipe.

As shown in FIG. 3, the sipe 102 may include a center section 302 located axially between the opposing first wall 201-1 and the second wall 201-2. The opposing first wall 201-1 and the second wall 201-2 are at an acute angle with respect to the radial direction of the tire, which results in the sipe 102 having the bidirectional protrusions 204 and the recesses 202. The bidirectional protrusions 204 and the recesses 202 allow the tire to function as intended regardless of the rolling direction of the tire. Additionally, the bidirectional protrusions 204 and the recesses 202 may ensures same level of interlocking, thereby, providing performance benefits in both direction of rotation. The bidirectional protrusions 204 and the recesses 202 may also provide equal levels of force variation and stiffness in both direction of rotation of tires, thereby creating symmetricity. This improves the overall steering stability performance of the tire in harsh conditions. Also, the projection 206 between the protrusion 204 and the corresponding recess 202 on the sipe 102 avoids the complete closure of the sipe 102, hence improving the wet steering performance of the tire by providing adequate water channeling as discussed above.

Although implementations of a tire are described, it is to be understood that the present subject matter is not necessarily limited to the specific features of the systems described herein. Rather, the specific features are disclosed as implementations for the tire.

1. A pneumatic tire comprising:
one or more three-dimensional sipes disposed of laterally in at least one tread block, wherein each of the one or more 3D sipes has a zig-zag shape in radial, width, and circumferential directions of the pneumatic tire,
each of the one or more 3D sipes has:
a first wall and a second wall on either side of the width direction of the pneumatic tire, the first wall has a pattern defined by a plurality of protrusions and recesses and the second wall has a pattern corresponding to the pattern of the first wall each of the plurality of protrusion and the recess having a flat interfacing surface
wherein:
a height of the protrusion and the recess lies in a range of 35-50% of a width of the 3D sipe
a distance of the protrusion and the corresponding recess from a top surface of the 3D sipe lies in a range of 10-20% of a depth of the 3D sipe and
a length of the flat interfacing surface lies in a range of 10-25% of the depth of the 3D sipe
at least one projection formed between a consecutive protrusion and recess on either the first wall or the second wall
wherein a distance of the consecutive protrusion and recess from a bottom surface of the 3D sipe lies in a range of 30-60% of the depth of the 3D sipe and
wherein:
a height of the at least one projection lies in a range of 10-15% of the width of the 3D sipe and
a width of the at least one projection lies in a range of 10-15% of the depth of the 3D sipe.

2. The pneumatic tire as claimed in claim 1, wherein the protrusion and the recess are arranged alternatively on the sidewall as well as side wall of the sipe.

3. The pneumatic tire as claimed in claim 1, wherein a side wall of the protrusion and a side wall of the recess extends with respect to the width direction of the 3D sipe and terminates at the flat interfacing surface

4. The pneumatic tire as claimed in claim 3, wherein the side wall of the protrusion and the side wall of the recess makes an angle of inclination with respect to the width direction of the 3D sipe that lies in a range less than 90.

5. The pneumatic tire as claimed in claim 1, wherein the protrusion and the recess have a substantially triangular cross-section.

6. The pneumatic tire as claimed in claim 1, wherein the depth of the 3D sipe is at 85% of Non-Skid depth of the tread block.

7. The pneumatic tire as claimed in claim 1, wherein the pneumatic tire is a passenger car tire and the depth of the 3D sipe lies in range of 6 mm to 12 mm of the non-skid depth of the tread block.

8. The pneumatic tire as claimed in claim 1, wherein the pneumatic tire is a truck and bus radial tire and the depth of the 3D sipe lies in range of 12 mm to 20 mm of the non-skid depth of the tread block.
